(19) United States
(12) Patent Application Publication
(10) Pub. No.: US 2015/0227098 A1
(43) Pub. Date: Aug. 13, 2015

(54) FIXING BELT, FIXING DEVICE AND IMAGE FORMING APPARATUS

(71) Applicant: Konica Minolta, Inc., Tokyo (JP)

(72) Inventors: Toru KIKUCHI, Tokyo (JP); Masanori MURAKAMI, Aichi (JP)

(21) Appl. No.: 14/608,986

(22) Filed: Jan. 29, 2015

(30) Foreign Application Priority Data
Feb. 7, 2014 (JP) 2014-022440

(51) Int. Cl. G03G 15/20

(52) U.S. Cl. CPC G03G 15/2057

(57) ABSTRACT

A fixing belt includes: a first base material layer; a first elastic layer provided on the first base material layer; and a first surface releasing layer provided on the first elastic layer, in which an indentation depth (ISO14577-1) on the first surface releasing layer measured at a pushing load of 300 [N/m²] is 100 [μm] to 150 [μm], both inclusive.

### CROSS REFERENCE TO RELATED APPLICATIONS

This application is entitled and claims the benefit of Japanese Patent Application No. 2014-022440, filed on Feb. 7, 2014, the disclosure of which including the specification, drawings and abstract is incorporated herein by reference in its entirety.

### BACKGROUND OF THE INVENTION

1. Field of the Invention

The present invention relates to a fixing belt, a fixing device and an image forming apparatus.

2. Description of Related Art

In general, an electrophotographic image forming apparatus (such as a printer, a copy machine, and a fax machine) is configured to irradiate (expose) a charged photoconductor with (to) laser light based on image data to form an electrostatic latent image on the surface of the photoconductor. The electrostatic latent image is then visualized by supplying toner from a developing device to the photoconductor (image carrier) on which the electrostatic latent image is formed, whereby a toner image is formed. Further, the toner image is directly or indirectly transferred to a sheet, followed by heating and pressurization, whereby an image is formed on the sheet.

An example of the fixing device that fixes a toner image in the above-mentioned manner is a heat-fixing type fixing device that applies heat and pressure on a sheet on which a toner image has been transferred while passing the sheet through a fixing nip formed by a fixing side member such as a fixing roller or a fixing belt and by a back side supporting member such as a pressure roller or a pressing belt which is brought into pressure contact with the fixing side member.

Japanese Patent Application Laid-Open No. 2010-204371 discloses, as a technique relating to fixing devices, a technique of reducing excessive temperature rising in a non-sheet passing region of a fixing device of induction heating type.

In addition, Japanese Patent Application Laid-Open No. 2013-130731 discloses a technique of improving fixation performance for sheets having large surface irregularity. To be more specific, the technique disclosed in Japanese Patent Application Laid-Open No. 2013-130731 relates to a fixing belt including a belt base material, a belt elastic layer formed on the surface of the belt base material, and a belt releasing layer formed on the surface of the belt elastic layer and configured to make contact with a toner image on a recording medium, in which: the thickness of the belt releasing layer is set to 10 [μm] to 15 [μm], both inclusive; the JIS-A hardness of the belt elastic layer is set to 20 [degrees] or smaller; and the surface pressure at the fixing nip portion is set to 1.2 [kgf/cm²] to 3.0 [kgfcm²], both inclusive.

However, conventional fixing devices such as that disclosed in Japanese Patent Application Laid-Open No. 2010-204371 may cause a problem that favorable fixation performance may not be ensured for sheets having large surface irregularity such as embossed sheets. In addition, while, in the technique disclosed in Japanese Patent Application Laid-Open No. 2013-130731, fixation performance is improved by improving the followability to the irregularity formed on the surface of a sheet, the thickness of the belt releasing layer is 15 [μm] or smaller, and such a configuration may cause another problem that the durability of the fixing belt for the sheet may be lowered.

### SUMMARY OF THE INVENTION

An object of the present invention is to provide a fixing belt, a fixing device and an image forming apparatus which can achieve favorable fixation performance and durability for sheets having large surface irregularity.

To achieve the abovementioned object, a fixing belt reflecting one aspect of the present invention includes: a first base material layer; a first elastic layer provided on the first base material layer; and a first surface releasing layer provided on the first elastic layer, wherein an indentation depth (ISO14577-1) on the first surface releasing layer measured at a pushing load of 300 [N/m²] is 100 [μm] to 150 [μm], both inclusive.

Desirably, in the fixing belt, the first elastic layer has a hardness (JIS K7312) of 3 [°] to 8[°], both inclusive, and the first elastic layer has a thickness of 300 [μm] to 500 [μm], both inclusive.

Desirably, in the fixing belt, the first surface releasing layer has a thickness of 20 [μm] to 40 [μm], both inclusive.

A fixing device reflecting another aspect of the present invention includes: the fixing belt according to claim 1; and a pressure roller that is brought into pressure contact with an outer peripheral surface of the fixing belt so as to form a fixing nip, wherein the pressure roller includes a second elastic layer, and a second surface releasing layer provided on the second elastic layer, wherein the second elastic layer has a thickness of 2 [mm] to 4 [mm], both inclusive.

Desirably, in the fixing device, the second elastic layer has a hardness (JIS K7312) of 3[°] to 20[°], both inclusive.

Desirably, in the fixing device, the second elastic layer has a hardness (JIS K7312) of 5[°] to 15[°], both inclusive.

Desirably, in the fixing device, a linear velocity of the fixing device is 300 [mm/s] to 900 [mm/s], both inclusive.

An image forming apparatus reflecting another aspect of the present invention includes the fixing device.

### BRIEF DESCRIPTION OF DRAWINGS

The present invention will become more fully understood from the detailed description given hereinbelow and the appended drawings which are given by way of illustration only, and thus are not intended as a definition of the limits of the present invention, and wherein:

FIG. 1 schematically illustrates a general configuration of an image forming apparatus of a present embodiment;

FIG. 2 illustrates a principal part of a control system of the image forming apparatus of the present embodiment;

FIG. 3 schematically illustrates a configuration of a fixing section of the present embodiment;

FIG. 4 is a table showing relationships between indentation depth and fixation performance or durability for an uneven sheet;

FIG. 5 is a table showing relationships between a thickness or a hardness of an elastic layer (fixing belt) and fixation performance for an uneven sheet;

FIG. 6 is a table showing relationships among a thickness and a hardness of the elastic layer (fixing belt) and durability for an uneven sheet;

FIG. 7 schematically illustrates a configuration for forming a fixing nip;

FIG. 8 is a table showing relationships between a hardness of the elastic layer (fixing belt) and a pressure exerted on a recess of an uneven sheet;

FIG. 9 is a table showing relationships between a thickness of an elastic layer (lower pressure roller) and fixation performance or durability for an uneven sheet; and

FIG. 10 is a table showing relationships among a linear velocity of the fixing section and fixation performance for an uneven sheet.

### DESCRIPTION OF THE PREFERRED EMBODIMENTS

In the following, an embodiment is described in detail with reference to the drawings.

### Configuration of Image Forming Apparatus 1

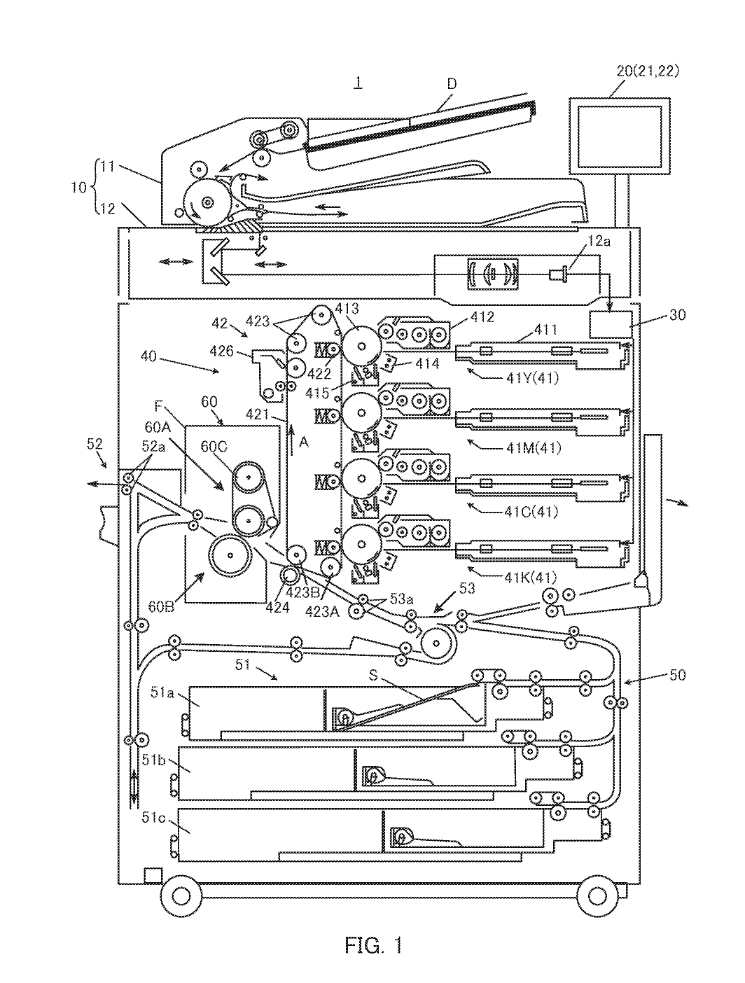

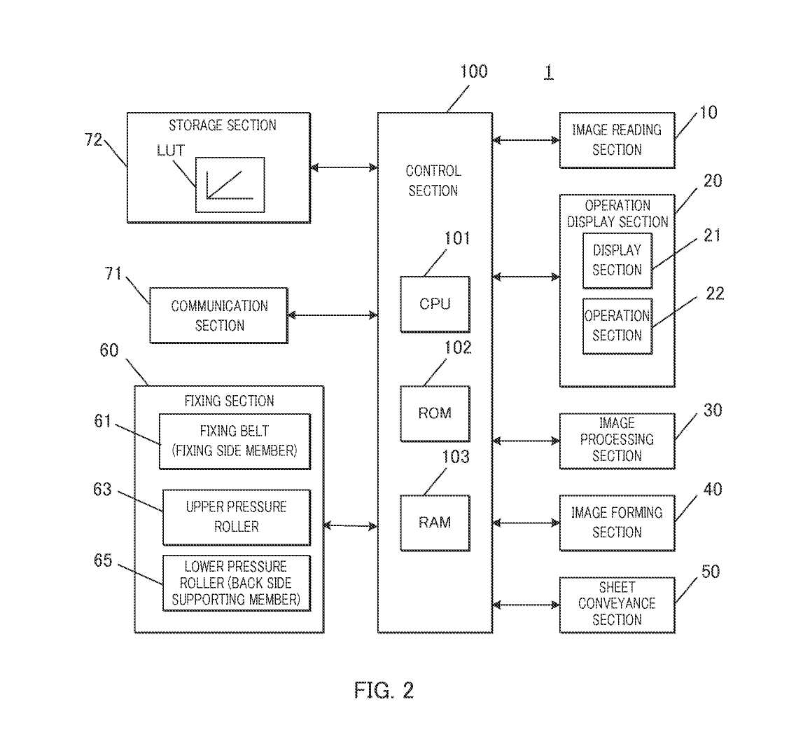

FIG. 1 illustrates an overall configuration of image forming apparatus 1 according to the embodiment of the present invention. FIG. 2 illustrates a principal part of a control system of image forming apparatus 1 according to the embodiment. Image forming apparatus 1 illustrated in FIGS. 1 and 2 is a color image forming apparatus with an intermediate transfer system using electrophotographic process technology. That is, image forming apparatus 1 transfers (primary-transfers) toner images of yellow (Y), magenta (M), cyan (C), and black (K) formed on photoconductor drums 413 to intermediate transfer belt 421, and superimposes the toner images of the four colors on one another on intermediate transfer belt 421. Then, image forming apparatus 1 transfers (secondary-transfers) the resultant image to sheet S, to thereby form an image.

A longitudinal tandem system is adopted for image forming apparatus 1. In the longitudinal tandem system, respective photoconductor drums 413 corresponding to the four colors of YMCK are placed in series in the travelling direction (vertical direction) of intermediate transfer belt 421, and the toner images of the four colors are sequentially transferred to intermediate transfer belt 421 in one cycle.

As illustrated in FIG. 2, image forming apparatus 1 includes image reading section 10, operation display section 20, image processing section 30, image forming section 40, sheet conveyance section 50, fixing section 60, and control section 100.

Control section 100 includes central processing unit (CPU) 101, read only memory (ROM) 102, random access memory (RAM) 103 and the like. CPU 101 reads a program suited to processing contents out of ROM 102, develops the program in RAM 103, and integrally controls an operation of each block of image forming apparatus 1 in cooperation with the developed program. At this time, CPU 101 refers to various kinds of data stored in storage section 72. Storage section 72 is composed of, for example, a non-volatile semiconductor memory (so-called flash memory) or a hard disk drive.

Control section 100 transmits and receives various data to and from an external apparatus (for example, a personal computer) connected to a communication network such as a local area network (LAN) or a wide area network (WAN), through communication section 71. Control section 100 receives, for example, image data transmitted from the external apparatus, and performs control to form an image on sheet S on the basis of the image data (input image data). Communication section 71 is composed of, for example, a communication control card such as a LAN card.

Image reading section 10 includes auto document feeder (ADF) 11, document image scanner (scanner) 12, and the like.

Auto document feeder 11 causes a conveyance mechanism to feed document D placed on a document tray, and sends out document D to document image scanner 12. Auto document feeder 11 enables images (even both sides thereof) of a large number of documents D placed on the document tray to be successively read at once.

Document image scanner 12 optically scans a document fed from auto document feeder 11 to its contact glass or a document placed on its contact glass, and images light reflected from the document on the light receiving surface of charge coupled device (CCD) sensor 12a, to thereby read the document image. Image reading section 10 generates input image data on the basis of a reading result provided by document image scanner 12. Image processing section 30 performs predetermined image processing on the input image data.

Operation display section 20 includes, for example, a liquid crystal display (LCD) with a touch panel, and functions as display section 21 and operation section 22. Display section 21 displays various operation screens, image statuses, the operating conditions of each function, and the like in accordance with display control signals received from control section 100. Operation section 22 includes various operation keys such as a numeric keypad and a start key, receives various input operations performed by a user, and outputs operation signals to control section 100.

Image processing section 30 includes a circuit that performs digital image processing suited to initial settings or user settings on the input image data, and the like. For example, image processing section 30 performs tone correction on the basis of tone correction data (tone correction table), under the control of control section 100. In addition to the tone correction, image processing section 30 also performs various correction processes such as color correction and shading correction as well as a compression process, on the input image data. Image forming section 40 is controlled on the basis of the image data that has been subjected to these processes.

Image forming section 40 includes: image forming units 41Y, 41M, 41C, and 41K for images of colored toners respectively containing a Y component, an M component, a C component, and a K component on the basis of the input image data; intermediate transfer unit 42; and the like.

Image forming units 41Y, 41M, 41C, and 41K for the Y component, the M component, the C component, and the K component have a similar configuration. For ease of illustration and description, common elements are denoted by the same reference signs. Only when elements need to be discriminated from one another, Y, M, C, or K is added to their reference signs. In FIG. 1, reference signs are given to only the elements of image forming unit 41Y for the Y component, and reference signs are omitted for the elements of other image forming units 41M, 41C, and 41K.

Image forming unit 41 includes exposure device 411, developing device 412, photoconductor drum 413, charging device 414, drum cleaning device 415 and the like.

Photoconductor drums 413 are, for example, negative-charge-type organic photoconductor (OPC) formed by sequentially laminating an under coat layer (UCL), a charge generation layer (CGL), and a charge transport layer (CTL) on the circumferential surface of a conductive cylindrical body (aluminum-elementary tube) which is made of aluminum and has a diameter of 80 [mm] The charge generation layer is made of an organic semiconductor in which a charge generating material (for example, phthalocyanine pigment) is dispersed in a resin binder (for example, polycarbonate), and generates a pair of positive charge and negative charge through exposure to light by exposure device 411. The charge transport layer is made of a layer in which a hole transport material (electron-donating nitrogen compound) is dispersed in a resin binder (for example, polycarbonate resin), and transports the positive charge generated in the charge generation layer to the surface of the charge transport layer.

Control section 100 controls a driving current supplied to a driving motor (not shown in the drawings) that rotates photoconductor drums 413, whereby photoconductor drums 413 is rotated at a constant circumferential speed.

Charging device 414 evenly negatively charges the surface of photoconductor drum 413. Exposure device 411 is composed of, for example, a semiconductor laser, and configured to irradiate photoconductor drum 413 with laser light corresponding to the image of each color component. Since the positive charge is generated in the charge generation layer of photoconductor drum 413 and is transported to the surface of the charge transport layer, the surface charge (negative charge) of photoconductor drum 413 is neutralized. An electrostatic latent image of each color component is formed on the surface of photoconductor drum 413 by the potential difference from its surroundings.

Developing device 412 is, for example, a two-component development type developing device, and attaches the toners (an oil-free toner in which wax is contained in toner particles) of respective color components to the surface of photoconductor drums 413 to visualize the electrostatic latent image, thereby forming a toner image.

Drum cleaning device 415 includes a drum cleaning blade that is brought into sliding contact with the surface of photoconductor drum 413, and removes residual toner that remains on the surface of photoconductor drum 413 after the primary transfer.

Intermediate transfer unit 42 includes intermediate transfer belt 421, primary transfer roller 422, a plurality of support rollers 423, secondary transfer roller 424, belt cleaning device 426 and the like.

Intermediate transfer belt 421 is composed of an endless belt, and is stretched around the plurality of support rollers 423 in a loop form. At least one of the plurality of support rollers 423 is composed of a driving roller, and the others are each composed of a driven roller. Preferably, for example, roller 423A disposed on the downstream side in the belt travelling direction relative to primary transfer rollers 422 for K-component is a driving roller. With this configuration, the travelling speed of the belt at a primary transfer section can be easily maintained at a constant speed. When driving roller 423A rotates, intermediate transfer belt 421 travels in arrow A direction at a constant speed.

Primary transfer rollers 422 are disposed to face photoconductor drums 413 of respective color components, on the inner periphery side of intermediate transfer belt 421. Primary transfer rollers 422 are brought into pressure contact with photoconductor drums 413 with intermediate transfer belt 421 therebetween, whereby a primary transfer nip for transferring a toner image from photoconductor drums 413 to intermediate transfer belt 421 is formed.

Secondary transfer roller 424 is disposed to face roller 423B (hereinafter referred to as “backup roller 423B”) disposed on the downstream side in the belt travelling direction relative to driving roller 423A, on the outer peripheral surface side of intermediate transfer belt 421. Secondary transfer roller 424 is brought into pressure contact with backup roller 423B with intermediate transfer belt 421 therebetween, whereby a secondary transfer nip for transferring a toner image from intermediate transfer belt 421 to sheet S is formed.

When intermediate transfer belt 421 passes through the primary transfer nip, the toner images on photoconductor drums 413 are sequentially primary-transferred to intermediate transfer belt 421. To be more specific, a primary transfer bias is applied to primary transfer rollers 422, and electric charge of the polarity opposite to the polarity of the toner is applied to the rear side (the side that makes contact with primary transfer rollers 422) of intermediate transfer belt 421, whereby the toner image is electrostatically transferred to intermediate transfer belt 421.

Thereafter, when sheet S passes through the secondary transfer nip, the toner image on intermediate transfer belt 421 is secondary-transferred to sheet S. To be more specific, a secondary transfer bias is applied to secondary transfer roller 424, and electric charge of the polarity opposite to the polarity of the toner is applied to the rear side (the side that makes contact with secondary transfer roller 424) of sheet S, whereby the toner image is electrostatically transferred to sheet S. Sheet S on which the toner images have been transferred is conveyed toward fixing section 60.

Belt cleaning device 426 includes a belt cleaning blade that is brought into sliding contact with the surface of intermediate transfer belt 421, and removes residual toner that remains on the surface of intermediate transfer belt 421 after the secondary transfer. A configuration (so-called belt-type secondary transfer unit) in which a secondary transfer belt is installed in a stretched state in a loop form around a plurality of support rollers including a secondary transfer roller may also be adopted in place of secondary transfer roller 424.

Fixing section 60 includes upper fixing section 60A having a fixing side member disposed on a fixing surface (the surface on which a toner image is formed) side of sheet S, lower fixing section 60B having a back side supporting member disposed on the rear surface (the surface opposite to the fixing surface) side of sheet S, heating source 60C, and the like. Back side supporting member is brought into pressure contact with the fixing side member, whereby a fixing nip for conveying sheet S in a tightly sandwiching manner is formed.

Fixing section 60 applies, at the fixing nip, heat and pressure to sheet S on which a toner image has been secondary-transferred, thereby fixing the toner image on sheet S. Fixing section 60 is disposed as a unit in fixing part F. In addition, fixing part F may be provided with an air-separating unit that blows air to separate sheet S from the fixing side member or the back side supporting member. Fixing section 60 will be described in detail later.

Sheet conveyance section 50 includes sheet feeding section 51, sheet ejection section 52, conveyance path section 53 and the like. Three sheet feed tray units 51a to 51c included in sheet feeding section 51 store sheets S (standard sheets, special sheets) discriminated on the basis of the basis weight, the size, and the like, for each type set in advance. Conveyance path section 53 includes a plurality of pairs of conveyance rollers such as a pair of registration rollers 53a.

The recording sheets S stored in sheet tray units 51a to 51c are output one by one from the uppermost, and conveyed to image forming section 40 by conveyance path section 53. At this time, the registration roller section in which the pair of registration rollers 53a are arranged corrects skew of sheet S fed thereto, and the conveyance timing is adjusted. Then, in image forming section 40, the toner image on intermediate transfer belt 421 is secondary-transferred to one side of sheet S at one time, and a fixing process is performed in fixing section 60. Sheet S on which an image has been formed is ejected out of the image forming apparatus by sheet ejection section 52 including sheet discharging rollers 52a.

### Configuration of Fixing Section 60

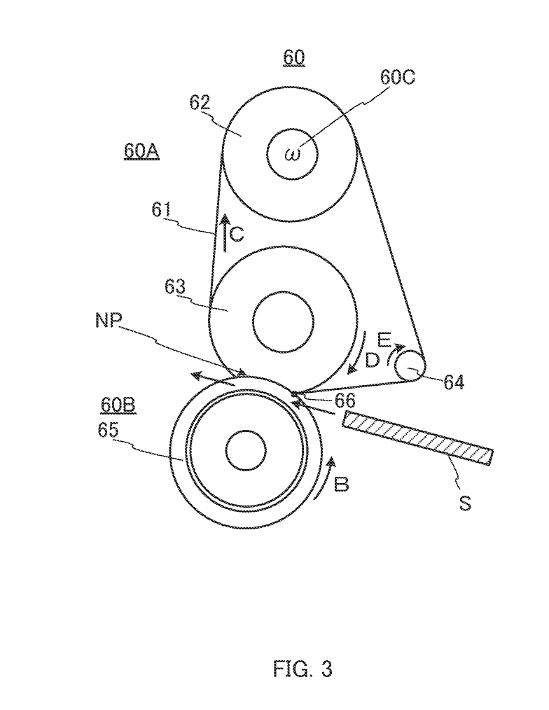

Next, with reference to FIG. 3, the configuration of fixing section 60 will be described. FIG. 3 is a schematic view illustrating the configuration of fixing section 60.

It is to be noted that fixing section 60 and control section 100 function as a fixing device. Fixing section 60 and control section 100 may be configured as a unit attached to image forming apparatus 1, or may be separately incorporated in image forming apparatus 1 so as to function as a fixing device.

Upper fixing section 60A includes endless fixing belt 61, heating roller 62, upper pressure roller 63 and stretching member 64, which serve as a fixing side member (belt heating system). Fixing belt 61 is installed in a stretched state around heating roller 62, upper pressure roller 63, and stretching member 64 (tension roller) at a predetermined belt tensile force (for example, 400 [N]).

Stretching member 64 has an outer diameter of 15 [mm], for example. Stretching member 64 has an inverted crown form (V-form) in which the diameter of an end portion is greater than that of the center portion in its axial direction.

Stretching member 64 is located at a position on a straight line tilted 65 degrees to the sheet entrance side about endpoint 66 relative to a straight line that is parallel to a straight line connecting the center of upper pressure roller 63 and the center of lower pressure roller 65, and passes through endpoint 66 on the upstream side of fixing nip NP in the rotational direction of fixing belt 61.

Fixing belt 61 has an outer diameter of 120 [mm], and has a configuration in which the outer peripheral surface of a 70 [μm]-thick base material layer (first base material layer) made of PI (polyimide), for example, is covered with heat-resistant silicon rubber (hardness JIS-A30[°]) serving as an elastic layer (first elastic layer), and further, the surface layer is covered or coated with a tube serving as a surface releasing layer (first surface releasing layer) made of PFA (perfluoro alkoxy), which is a heat-resistant resin. Together with lower pressure roller 65, fixing belt 61 forms fixing nip NP.

Fixing belt 61 makes contact with sheet S on which a toner image is formed, and thermally fixes the toner image on sheet S at a fixation temperature (for example, 160 to 200[° C.]). The fixing temperature is a temperature at which a heat energy required for melting the toner on sheet S can be obtained, and the fixing temperature differs depending on factors such as the type of sheet S on which an image is to be formed.

Heating roller 62 applies heat to fixing belt 61. Heating roller 62 is provided therein with heating source 60C (halogen heater) for applying heat to fixing belt 61. Heating roller 62 has an outer diameter of, for example, 58 [mm], and has a configuration in which the outer peripheral surface of a cylindrical mandrel made of aluminum or the like is coated with a resin layer of PTFE, for example.

The temperature of heating source 60C is controlled by control section 100. Heating source 60C applies heat to heating roller 62, and as a result, fixing belt 61 is heated.

Upper pressure roller 63 has an outer diameter of 70 [mm], and has a configuration in which a solid mandrel made of metal such as iron is covered with 20 [mm]-thick heat-resistant silicone rubber (hardness: JIS-A10[°]) as an elastic layer, and is further coated with a 5 to 30 [nm]-thick resin layer of PTFE, which is low frictional and heat-resistant resin. Upper pressure roller 63 is brought into pressure contact with lower pressure roller 65, which is rotated by a main driving source (not illustrated) in fixing section 60, with fixing belt 61 therebetween.

Lower fixing section 60B includes, for example, lower pressure roller 65 serving as a back side supporting member (roller pressing type). Lower pressure roller 65 has an outer diameter of 70 [mm], and has a configuration in which the outer peripheral surface of an elastic layer (second elastic layer) made of heat-resistant silicone rubber (hardness JIS-A30[°]) is covered with a resin layer of PFA tube having a thickness of 30 to 100 [μm] that serves as a surface releasing layer (second surface releasing layer).

Control section 100 controls the main driving source (drive motor) to rotate lower pressure roller 65 in arrow B direction (counterclockwise direction). The driving control of the driving motor (for example, on/off of the rotation, the circumferential speed, and the like) is performed by control section 100. The circumferential speed of lower pressure roller 65 is, for example, 460 [mm/s].

Lower pressure roller 65 is provided therein with a heating source (not illustrated) such as a halogen heater or the like. When heat is generated by the heating source, lower pressure roller 65 is heated. Control section 100 controls the power to be supplied to the heating source, so as to control the temperature of lower pressure roller 65 at a predetermined temperature (for example, 80 to 120[° C.]).

Lower pressure roller 65 is brought into pressure contact with upper pressure roller 63 at a predetermined fixing load (for example, 2650 [N]) with fixing belt 61 therebetween. Thus, fixing nip NP for conveying sheet S in a tightly sandwiching manner is formed between fixing belt 61 and lower pressure roller 65. The contact pressure (surface pressure) between fixing belt 61 and lower pressure roller 65 in fixing nip NP is, for example, 30.67 [N/cm²].

When lower pressure roller 65 is rotated in arrow B direction, fixing belt 61 rotates in arrow C direction (clockwise direction) to follow the rotation of lower pressure roller 65. Along with this rotation, upper pressure roller 63 is rotated in arrow D direction (clockwise direction). In addition, stretching member 64 is rotated in arrow E direction (clockwise direction). At the time of fixation of sheet S, the circumferential speed of fixing belt 61 is the same as that of lower pressure roller 65 (for example, 460 [mm/s]).

In fixing section 60 described above, the present inventors found that difference is caused in the fixation performance and the durability for sheet S having large surface irregularity (hereinafter referred to as “uneven sheet”), depending on the difference in the indentation depth (ISO14577-1) on the surface releasing layer of fixing belt 61. As the uneven sheet, LEATHAC 66 having basis weight of 151 [gsm] was used.

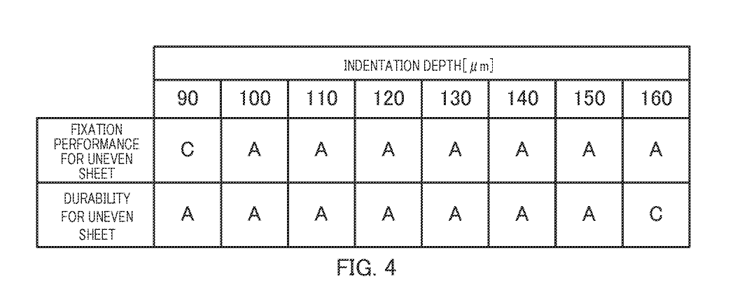

FIG. 4 shows evaluations on the fixation performance and durability for an uneven sheet on the following evaluation criteria in the case where fixation on uneven sheets are performed using fixing belts 61 differing in indentation depth on the surface releasing layer within the range of 90 [μm] to 160 [μm].

### (Fixation Performance for Uneven Sheet)

A: No fixation problem was found
C: Many fixation problems were found

### (Durability for Uneven Sheet)

A: No durability problem was caused
C: Tube wrinkle or belt tear was caused on the surface releasing layer (surface of fixing belt 61), and a durability problem was caused

Here, the indentation depth on the surface releasing layer was measured using a surface film physical property tester (available from H. FISCHER) by continuously exerting a pushing load of 300 [N/m²] for 10 seconds on a Vickers square pyramid diamond indenter having a facing angle of 136[°].

As illustrated in FIG. 4, when fixation was performed on an uneven sheet by using fixing belt 61 in which the indentation depth on the surface releasing layer of fixing belt 61 is 90 [μm], many fixation problems were found. The reason for this is considered that the elasticity of the surface releasing layer is insufficient, and the followability to an uneven sheet is low. In addition, when fixation was performed on an uneven sheet by using fixing belt 61 in which the indentation depth on the surface releasing layer of fixing belt 61 is 160 [μm], durability problem was caused. The reason for this is considered that PFA tube wrinkle was caused. From the above results, it was found that favorable fixation performance and durability for an uneven sheet can be achieved when the indentation depth on the surface releasing layer of fixing belt 61 is within the range of 100 [μm] to 150 [μm], both inclusive.

In addition, the present inventors found that difference is caused in fixation performance and durability for an uneven sheet depending on the difference in hardness (JIS K7312) and thickness of the elastic layer of fixing belt 61.

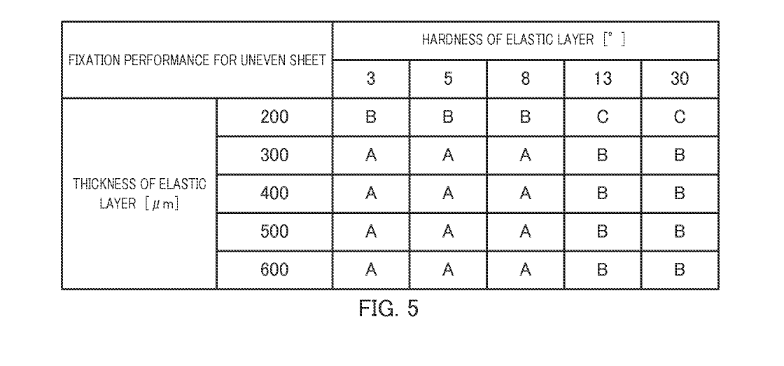

FIG. 5 shows evaluations on the fixation performance for an uneven sheet on the following evaluation criteria in the case where fixation on uneven sheets are performed using fixing belts 61 differing in hardness and thickness within the range of 3 to 30[°] and within the range of 200 [μm] to 600 [μm], respectively.

### (Fixation Performance for Uneven Sheet)

A: No fixation problem was found
B: No practical problem was found although fixation problem was found in some parts
C: Many fixation problems were found

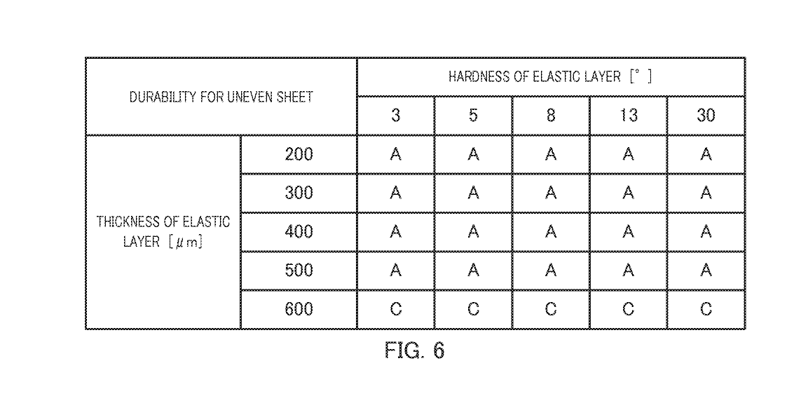

FIG. 6 shows evaluations on the durability for an uneven sheet on the following evaluation criteria in the case where fixation on uneven sheets are performed using fixing belts 61 differing in hardness and thickness within the range of 3[°] to 30[°] and within the range of 200 [μm] to 600 [μm], respectively.

### (Durability for Uneven Sheet)

A: No durability problem was caused

C: Tube wrinkle or belt tear was caused on the surface releasing layer (surface of fixing belt 61), and a durability problem was caused

As illustrated in FIG. 5, it was found that favorable fixation performance for an uneven sheet is achieved when fixation is performed on an uneven sheet using fixing belt 61 in which the hardness and thickness of the elastic layer are respectively within the range of 3[°] to 8[°] and the range of 300 [μm] to 600 [μm]. The reason for this is considered that fixing belt 61 sufficiently followed the irregularity on the surface of the sheet. In addition, as illustrated in FIG. 6, it was found that favorable durability for an uneven sheet is achieved when fixation is performed on an uneven sheet using fixing belt 61 in which the hardness and thickness of the elastic layer are respectively within the range of 3[°] to 30[°] and the range of 200 [μm] to 600 [μm]. Meanwhile, when the thickness of the elastic layer of fixing belt 61 is 600 [μm], the durability problem was caused regardless of the hardness of the elastic layer. The reason for this is considered that PFA tube wrinkle was caused. From the results of FIGS. 5 and 6, it was found that favorable fixation performance for an uneven sheet is achieved when fixation is performed on an uneven sheet using fixing belt 61 in which the hardness and thickness of the elastic layer are respectively within the range of 3[°] to 8[°] and the range of 300 [μm] to 500 [μm]. Furthermore, from the viewpoint of achieving more favorable fixation performance and durability for an uneven sheet, the thickness of the surface releasing layer of fixing belt 61 is desirably 20 [am] to 40 [μm].

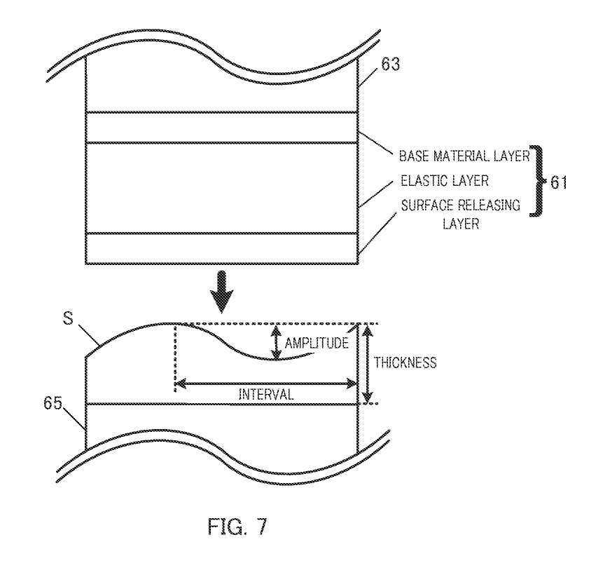

Next, through a simulation, the pressure exerted on the recess of an uneven sheet when fixation is performed using fixing belt 61 on the uneven sheet was calculated. FIG. 7 schematically illustrates a configuration for forming fixing nip NP. As illustrated in FIG. 7, when lower pressure roller 65 is brought into pressure contact with upper pressure roller 63 at a predetermined fixing load with fixing belt 61 therebetween, fixing nip NP for conveying uneven sheet S in a tightly sandwiching manner is formed between fixing belt 61 and lower pressure roller 65. Here, uneven sheet S has a thickness of 200 [μm], the amplitude of the irregularity of uneven sheet S is 70 [μm], and the interval of the irregularity is 1 [mm].

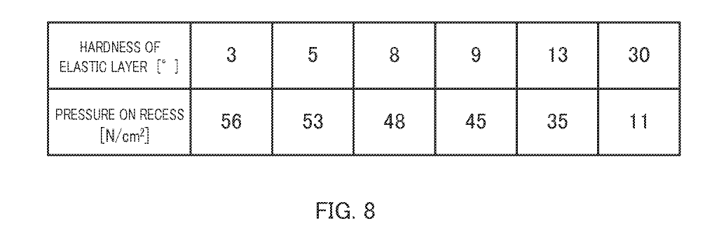

FIG. 8 is a table showing relationships between the hardness (JIS K7312) of the elastic layer and the pressure on the recess of uneven sheet S in the case where the thickness of the elastic layer of fixing belt 61 is 400 [μm]. As illustrated in FIG. 8, it was found that favorable fixation performance for uneven sheet S cannot be achieved when the hardness of the elastic layer is equal to or greater than 9[°], since the pressure exerted on the recess of uneven sheet S is equal to or smaller than 45 [N/cm²], and toner is peeled off from uneven sheet S at the time of fixation. Meanwhile, it was found that, when the hardness of the elastic layer is equal to or smaller than 8[°], the pressure on the recess of uneven sheet S is enhanced, and thus favorable fixation performance for uneven sheet S is achieved.

In addition, the present inventors found that difference is caused in fixation performance and durability for an uneven sheet depending on the difference in thickness of the elastic layer of lower pressure roller 65.

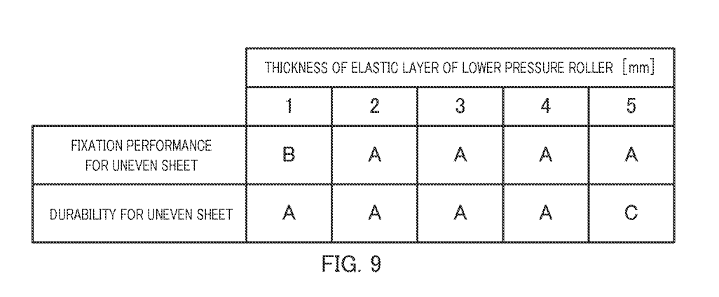

FIG. 9 shows evaluations on the fixation performance and durability for an uneven sheet on the following evaluation criteria when fixation on uneven sheets are performed using lower pressure rollers 65 differing in thickness of the elastic layer within the range of 1 [mm] to 5 [mm], in the case where the hardness and thickness of the elastic layer of fixing belt 61 are respectively 5[°] and 400 [μm].

### (Fixation Performance for Uneven Sheet)

A: No Fixation problem was found
B: No practical problem was found although fixation problem was found in some parts
C: Many fixation problems were found

### (Durability for Uneven Sheet)

A: No durability problem was caused
C: Tube wrinkle or belt tear was caused on the surface releasing layer (surface of fixing belt 61), and a durability problem was caused

As illustrated in FIG. 9, it was found that favorable fixation performance and durability for an uneven sheet are achieved when fixation on an uneven sheet was performed using lower pressure roller 65 in which the thickness of the elastic layer is 2 to 5 [mm] The reason for this is considered that the followability to an uneven sheet is enhanced as a result of increasing the thickness of the elastic layer of lower pressure roller 65, and thus the toner image formed on the uneven sheet could be uniformly heated and pressed. Furthermore, from the viewpoint of achieving more favorable fixation performance for an uneven sheet, the elastic layer of lower pressure roller 65 is preferably soft, and the hardness of the elastic layer (JIS K7312) is preferably 3[°] to 20[°], more preferably, 5[°] to 15[°]. The reason for this is that the followability to the irregularity is high when the elastic layer of lower pressure roller 65 is soft.

In addition, the present inventors found that difference is caused in fixation performance for an uneven sheet depending on the difference in hardness and thickness of the elastic layer of fixing belt 61 in the case where the linear velocity of fixing section 60 (the speed of sheet S passing through fixing nip NP) is changed.

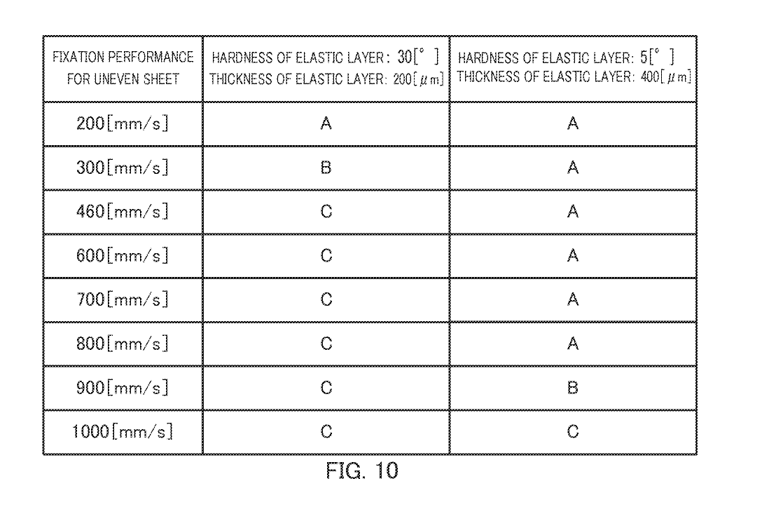

FIG. 10 shows evaluations on the fixation performance for an uneven sheet on the following evaluation criteria when fixation on uneven sheets were performed at different linear velocitys of fixing section 60 within the range of 200 to 1000 [mm/s] in the case where the hardness and thickness of the elastic layer of fixing belt 61 are respectively 30[°] and 200 [μm] or are respectively 5[°] and 400 [μm].

### (Fixation Performance for Uneven Sheet)

A: No Fixation problem was found
B: No practical problem was found although fixation problem was found in some parts
C: Many fixation problems were found

As illustrated in FIG. 10, it was found that, in the case where the hardness and thickness of the elastic layer of fixing belt 61 are respectively 30[°] and 200 [μm], or in other words, in the case of a configuration in which sufficient fixation performance on an uneven sheet cannot be achieved according to the results of FIG. 5, the linear velocity of fixing section 60 is required to be lowered to 200 [mm/s] or lower to achieve favorable fixation performance for an uneven sheet. Meanwhile, it was found that, in the case where the hardness and thickness of the elastic layer of fixing belt 61 are respectively 5[°] and 400 [μm], or in other words, in the case of a configuration in which sufficient fixation performance on an uneven sheet can be achieved according to the results of FIG. 5, the linear velocity of fixing section 60 is not required to be lowered to 200 [mm/s] or lower, and sufficient fixation performance on an uneven sheet is achieved by setting the linear velocity to 300 to 900 [mm/s]

### Effect of Present Embodiment

As has been described in detail, in the present embodiment, fixing belt 61 includes the base material layer, the elastic layer provided on the base material layer, and the surface releasing layer provided on the elastic layer, and the indentation depth on the surface releasing layer (ISO14577-1) measured at a pushing load of 300 [N/m²] is 100 [μm] to 150 [μm], both inclusive.

According to the above-mentioned configuration of the present embodiment, the followability to an uneven sheet is enhanced, and the toner image formed on the uneven sheet can be uniformly heated and pressed, and thus, a high quality image can be formed. In addition, it is possible to prevent tube wrinkle and belt tear from being caused on the surface (surface releasing layer) of fixing belt 61. Consequently, favorable fixation performance and durability for an uneven sheet can be achieved.

It should be understood by those skilled in the art that various modifications, combinations, sub-combinations and alterations may occur depending on design requirements and other factors in so far as they are within the scope of the appended claims or the equivalents thereof While the invention made by the present inventor has been specifically described based on the preferred embodiments, it is not intended to limit the present invention to the above-mentioned preferred embodiments but the present invention may be further modified within the scope and spirit of the invention defined by the appended claims.

What is claimed is:

1. A fixing belt comprising:
a first base material layer;
a first elastic layer provided on the first base material layer; and
a first surface releasing layer provided on the first elastic layer, wherein an indentation depth (ISO14577-1) on the first surface releasing layer measured at a pushing load of 300 [N/m²] is 100 [μm] to 150 [μm], both inclusive.

2. The fixing belt according to claim 1, wherein the first elastic layer has a hardness (JIS K7312) of 3[°] to 8[°], both inclusive, and the first elastic layer has a thickness of 300 [μm] to 500 [μm], both inclusive.

3. The fixing belt according to claim 2, wherein the first surface releasing layer has a thickness of 20 [μm] to 40 [μm], both inclusive.

4. A fixing device comprising:
the fixing belt according to claim 1; and
a pressure roller that is brought into pressure contact with an outer peripheral surface of the fixing belt so as to form a fixing nip, wherein
the pressure roller includes
a second elastic layer, and
a second surface releasing layer provided on the second elastic layer, wherein
the second elastic layer has a thickness of 2 [mm] to 4 [mm], both inclusive.

5. The fixing device according to claim 4, wherein the second elastic layer has a hardness (JIS K7312) of 3[°] to 20[°], both inclusive.

6. The fixing device according to claim 4, wherein the second elastic layer has a hardness (JIS K7312) of 5[°] to 15[°], both inclusive.

7. The fixing device according to claim 4, wherein a linear velocity of the fixing device is 300 [mm/s] to 900 [mm/s], both inclusive.

8. An image forming apparatus comprising the fixing device according to claim 4.
